(19) United States
(12) Patent Application Publication
(10) Pub. No.: US 2025/0077685 A1
(43) Pub. Date: Mar. 6, 2025

(54) AUTOMATED DETECTION OF KNOWN VULNERABILITIES

(71) Applicant: Robert Bosch GmbH, Stuttgart (DE)

(72) Inventors: Maria Irina Nicolae, Stuttgart (DE); Martin Ring, Lossburg (DE)

(21) Appl. No.: 18/788,429

(22) Filed: Jul. 30, 2024

(30) Foreign Application Priority Data
Sep. 6, 2023 (DE) 10 2023 208 599.2

(51) Int. Cl. G06F 21/57; G06F 21/56

(52) U.S. Cl. CPC G06F 21/577; G06F 21/563

(57) ABSTRACT

A computer-implemented method for automated detection of known vulnerabilities in a static test of software. The method includes extracting a data structure of a code of the software; identifying software component(s) on which the software depends based on the code, the extracted data structure and/or the software bill of materials of the software; evaluating, for identified software components, whether the software component is associated with a known vulnerability, potentially vulnerable software component{s) resulting; applying, for potentially vulnerable software component(s), a machine learning model to a description associated with the known vulnerability, wherein the machine learning model is trained and configured to determine at least one root cause from at least the description and a prompt; and evaluating the at least one potentially vulnerable software component as vulnerable or as not vulnerable or, optionally, as unevaluable based on the at least one root cause and the extracted data structure.

### CROSS REFERENCE

The present application claims the benefit under 35 U.S.C. § 119 of German Patent Application No. DE 10 2023 208 599.2 filed on Sep. 6, 2023, which is expressly incorporated herein by reference in its entirety.

### BACKGROUND INFORMATION

Software for controlling, regulating and/or monitoring technical systems, in particular cyber-physical systems such as vehicle computing units, is usually highly complex. Such software often comprises a plurality of software components such as software packages, functions and/or libraries, which are developed and provided independently of one another in organizational and/or economic terms. The number of software components, which also typically exist in different versions (sometimes also subversions), is often so large (e.g., more than 100, more than 500 or more than 1000 software components) that it is challenging for individual software engineers and even for entire software development departments to keep track of the different software components throughout the life cycle (development, testing, production and maintenance) of the software.

Software and its software components can be prone to errors. Software and/or its software components can be tested for errors using static software tests, for example, wherein, in contrast to dynamic software tests, the software is not executed. In the context of the present invention, the main problems are errors or vulnerabilities that impair or even endanger the security of the software, and thus of the technical system controlled, regulated and/or monitored by it. In practice, such security vulnerabilities (vulnerabilities for short) of individual software components are often only detected after a certain period of time, despite extensive testing. During the life cycle of software, its software components must therefore be continuously monitored and any vulnerabilities that arise must be addressed. Generally known vulnerabilities are particularly critical because they can easily be exploited by attackers.

Constantly updated and accessible lists and/or databases of general vulnerabilities are available. An example of this is the Common Vulnerabilities and Exposures (CVE), which is a referencing system under the US National Cybersecurity FFRDC and is maintained by the Mitre Corporation, the aim of which is to introduce a uniform naming convention for security gaps and other vulnerabilities in computer systems.

Often, the individual software components of software have a sufficiently high degree of complexity, so that a precise distinction should be made as to whether a known vulnerability associated with the software component actually represents a security risk. For example, a large software may have hundreds or thousands of vulnerabilities (many of which are false positives) that are related to the software components used in the software, but only about 3-10% of them are actually associated with a security risk to the software (known as true positives).

The present invention is therefore based on the problem of providing an automated but nevertheless reliable detection of relevant vulnerabilities, in particular wherein the number of false positives is to be reduced or eliminated.

### SUMMARY

A first general aspect of the present invention relates to a computer-implemented method for automated detection of known vulnerabilities in a static test of software. According to an example embodiment of the present invention, the method can comprise extracting a data structure of a code of the software. The method further comprises identifying one or more software components on which the software depends based on the code, the extracted data structure and/or the software bill of materials (SBOM). The method further comprises evaluating, for at least one identified software part, whether the software part is associated with a known vulnerability, wherein one or more potentially vulnerable pieces of software result. The method further comprises applying, for at least one potentially vulnerable piece of software, a machine learning model to a description associated with the known vulnerability, wherein the machine learning model is trained and configured to determine at least one root cause from at least the description and a prompt. The method further comprises evaluating the at least one potentially vulnerable piece of software as vulnerable or as not vulnerable or, optionally, as unevaluable based on the at least one root cause and the extracted data structure (and/or on the code).

The software can be designed to control, regulate and/or monitor a technical system, in particular a cyber-physical system, in particular at least one computing unit of a vehicle. The method can be performed in an electronic programming environment. The method can comprise outputting at least one software component evaluated as vulnerable, optionally via a user interface.

A second general aspect of the present invention relates to a computer system designed to carry out the computer-implemented method for automated detection of known vulnerabilities in a static test of software according to the first general aspect of the present invention (or an embodiment thereof).

A third general aspect of the present invention relates to a computer program designed to carry out the computer-implemented method for automated detection of known vulnerabilities in a static test of software according to the first general aspect of the present invention (or an embodiment thereof).

A fourth general aspect of the present invention relates to a computer-readable medium or signal that stores and/or contains the computer program according to the third general aspect of the present invention (or an embodiment thereof).

The method provided in this disclosure according to the first aspect of the present invention (or an embodiment thereof) is directed to automated detection of known vulnerabilities of software. This allows known vulnerabilities that are relevant to the software (or its software components) to be (better) identified. In particular, false positives can be significantly reduced or even eliminated completely. In practice, this is an advantage among other things because, due to the typically high complexity of the software and its software components, a large number of (even several hundred thousand) false positives can occur, which would be difficult to analyze in detail and identify as false positives with reasonable effort. Thanks to the automated and reliable detection disclosed here, (almost) only true positives are identified, which can then be addressed by changing the software. This can improve the security of the software and, for example, of the technical system controlled, regulated and/or monitored by the software, such as a vehicle.

### BRIEF DESCRIPTION OF THE DRAWINGS

FIGS. 1A-1B schematically illustrate computer-implemented methods for automated detection of known vulnerabilities in a static test of software, according to example embodiments of the present invention.

FIG. 2 schematically illustrates a data structure extracted from the code of the software, e.g. a control flow graph, according to an example embodiment of the present invention.

### DETAILED DESCRIPTION OF EXAMPLE EMBODIMENTS

The method according to the present invention provided in this disclosure is directed to automated detection of known vulnerabilities of software.

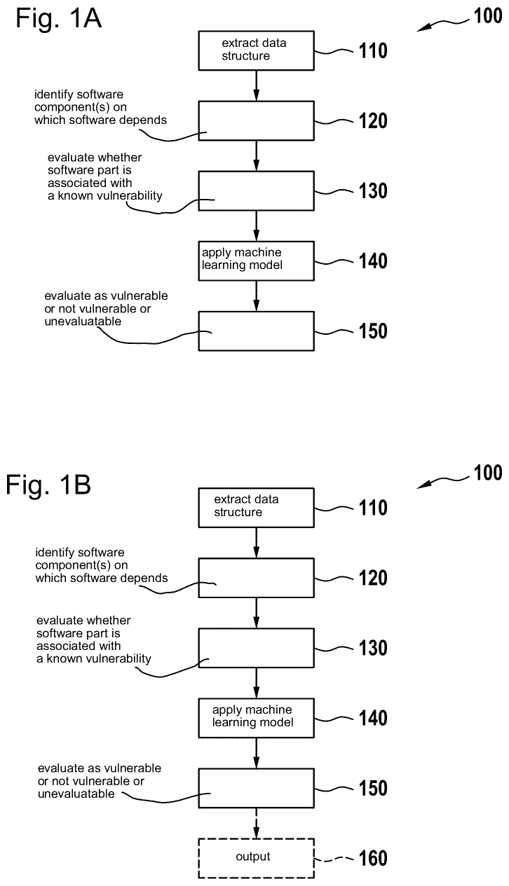

For this purpose, a computer-implemented method 100 is disclosed, schematically illustrated in FIGS. 1A-1B, for automated detection of known (i.e. at least known at the time the method 100 is carried out) vulnerabilities in a static test of software.

The method 100 can comprise extracting 110 a data structure 10 of a code of the software, wherein the data structure 10 is suitable for static testing of the software, for example. The data structure 10 can be suitable for static testing of the software if it represents a logic of the code. Alternatively or additionally, the data structure 10 can be suitable for static testing of the software if it is in a standard form, in particular in a parsable standard form. A data structure 10 can be a standard form if it is independent of the programming language in which the code is written. Alternatively or additionally, a data structure 10 can be a standard form if it is independent of the target platform on which the code is executed.

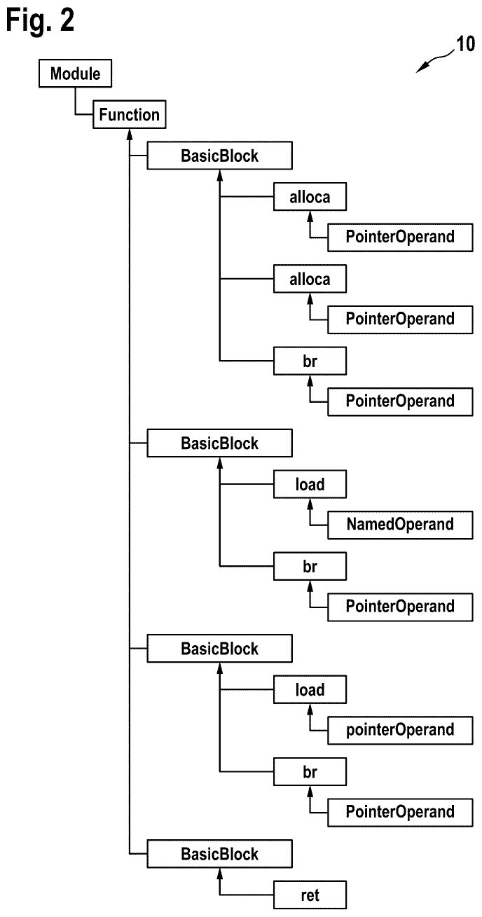

Alternatively or additionally, a data structure 10 can be a standard form if it is independent of compiler specifications. Alternatively or additionally, the data structure 10 can be suitable for static testing of the software if it contains less information than the code. An exemplary data structure 10 (abstract syntax tree) is shown schematically in FIG. 2.

The method 100 can comprise receiving the code of the software.

The method 100 further comprises identifying 120 one or more software components on which the software depends based on the code, the extracted 110 data structure 10 and/or the software bill of materials (SBOM). For example, identifying 120 the one or more software components can be based on the code. Alternatively or additionally, identifying 120 the one or more software components can be based on the extracted 110 data structure 10. Alternatively or additionally, identifying 120 the one or more software components can be based on the software bill of materials (SBOM) of the software. The one or more software components can, for example, be external software components. Identification based on the code can be done starting from source code, for example via a standard package manager, and starting from compiled binary code, for example by analyzing the included system files and/or the included executable files.

The method 100 further comprises evaluating 130, for at least one identified 120 software part, whether the software part is associated with a known vulnerability, wherein one or more potentially vulnerable software components result. The method 100 can comprise evaluating, for each identified 120 software part, whether the software part is associated with a known vulnerability. The evaluation 130 can, for example, comprise retrieving and comparing known vulnerabilities from a public and/or private database. For example, the Common Vulnerabilities and Exposures (CVE) are publicly accessible as a referencing system under the US National Cybersecurity FFRDC and maintained by the Mitre Corporation. An example extract from a list of known vulnerabilities is given below.

The method 100 further comprises applying 140, for at least one potentially vulnerable software part, a machine learning model to a description associated with the known vulnerability (associated with the potentially vulnerable software part), wherein the machine learning model is trained and configured to determine at least one root cause from at least the description and a prompt. The method 100 can comprise applying, for each potentially vulnerable software component, a machine learning model to a relevant description associated with the known vulnerability (associated with the relevant potentially vulnerable software component). For example, the description and/or prompt can be in English. Alternatively, the description and/or prompt can be in another language, such as German or Chinese. Using English can be beneficial because English is a major language for programming. The CVE, for example, continue to be published in English. Furthermore, a large language model comprised in the machine learning model can usually handle English well, because often a large part of the training data with which the large language model was trained was already in English. The prompt can comprise a syntax specification, e.g. regarding input data (e.g. format of the vulnerability entries) and/or output data (e.g. format of the root cause(s)) to the machine learning model. A syntax specification can be advantageous for further machine processing. An example prompt with a syntax specification is shown below.

The method comprises evaluating 150 the at least one potentially vulnerable software component as vulnerable or as not vulnerable or, optionally, as unevaluable based on the at least one root cause and the extracted 110 data structure 10 and/or on the code. The evaluation 150 based on the at least one root cause and the extracted 110 data structure 10 (instead of the code) can be advantageous, for example, if the data structure 10 is a standard form, in particular a parsable standard form, and optionally a root cause (e.g. a function) can be reliably found therein. Alternatively, the evaluation 150 can be based on the at least one root cause and the code (instead of the data structure 10). In such a case, it may be possible (e.g., even if the step of identifying 120 the one or more software components is not based on the data structure 10) to omit the step of extracting 110 the data structure of the software code (other than as shown in FIGS. 1A-1B).

The software can be designed to control, regulate and/or monitor a technical system. The technical system can, for example, be a cyber-physical system. Alternatively or additionally, the technical system can comprise at least one computing unit (e.g. a control unit) of a vehicle. For example, the technical system can be a braking system of a vehicle.

The method 100 can be performed in an electronic programming environment. This allows, for example, a user of the electronic programming environment, e.g. a software engineer, to initiate an action regarding a software component that is evaluated 150 as vulnerable. Alternatively or additionally, further automated analysis can be carried out in the electronic programming environment.

The method 100 can, as schematically illustrated in FIG. 1B, comprise outputting 160 at least one software component evaluated 150 as vulnerable. The outputting 160 can be done, for example, via a user interface. The user interface can, for example, comprise a screen and at least one input interface (keyboard, mouse, touchscreen). Alternatively or additionally, outputting 160 at least one software component evaluated as vulnerable 150 can be done, for example, via an output file. Thanks to the output 160 of at least one software component evaluated 150 as vulnerable, a user, e.g. a software engineer, can take action so that the vulnerability in the software is eliminated. This can improve the reliability and/or security of the software and of the technical system as a whole, in particular the cyber-physical system that is controlled, regulated and/or monitored by the software. For example, an action can comprise removing the software component evaluated 150 as vulnerable. Here, for example, the software component can be replaced by a software component in a new (improved) version. Alternatively or additionally, the action can comprise, for example, adapting the software components evaluated 150 as vulnerable.

The code can comprise source code or be source code. Alternatively or additionally, the code can comprise compiled binary code or be compiled binary code.

The data structure can comprise an abstract syntax tree or be an abstract syntax tree. An abstract syntax tree can be a hierarchical representation of a decomposition of code as text. Alternatively or additionally, the data structure can comprise a control flow graph or be a control flow graph, as shown schematically, for example, in FIG. 2. A control flow graph can be a directed graph that is used to describe the program flow of a computer program (here: the software). For example, a p-code (instruction set of a pseudo-machine, i.e. a virtual CPU) can first be generated from source code or compiled binary code, and the control flow graph can be generated from said p-code.

Extracting 110 the data structure 10 of the code can comprise generating an abstract syntax tree of the code (or a part thereof) and generating the control flow graph from the abstract syntax tree. Such an approach can be chosen, for example, when the data structure 10 is extracted 110 from source code.

A software component can comprise a software package. Alternatively or additionally, a software component can comprise a function. Alternatively or additionally, a software component can comprise a library. A (or each) software component can comprise one or more identifiers. Alternatively or additionally, a (or each) software component can comprise metadata. An identifier can, for example, comprise a unique name of a software package, a function and/or a library. The metadata can, for example, comprise a version number. Alternatively or additionally, the metadata can comprise a type of use. Alternatively or additionally, the metadata can comprise a configuration. Alternatively or additionally, the metadata can comprise a build option.

Evaluating 130, for at least one identified software component, whether the software component is associated with a known vulnerability can be based on a comparison of identifiers and/or metadata. In particular, evaluating 130 whether each identified 120 software component is associated with a known vulnerability can be based on a comparison of identifiers and/or metadata. In particular, each software component can, for example, have a unique name and be available in one version (optionally with a subversion). During the evaluation 130, for example, the names and versions can be compared.

The machine learning model can comprise a foundation model or be a foundation model. A foundation model can be a large machine learning model that has been trained on a large dataset at scale (often through self-supervised learning or semi-supervised learning) so that it can be adapted to a wide range of downstream tasks. In particular, the machine learning model can comprise a large language model (LLM) or be a large language model. A large language model can be a language model that is characterized by its size. In particular, the large language model can be a chatbot or have chatbot functionality.

Google BERT, for example, can be used as a large language model. Alternatively or additionally, for example, OpenAI's ChatGPT (e.g. in the version of May 24, 2023) can be used as a large language model. Alternatively or additionally, for example, Hugging Face Bloom can be used as a large language model.

Alternatively or additionally, the machine learning model can comprise or be a multi-domain model. For example, OpenAI's GPT-4 (e.g. the version of Mar. 14, 2023) can be used here.

The at least one root cause can be, for example, a function (that is affected, i.e. relevant with respect to the associated known vulnerability), in particular wherein the function can be included in the description (associated with the known vulnerability). Determining the at least one root cause can comprise filtering out the (at least one) feature from the description.

The prompt can comprise (or be) an instruction to the machine learning model (e.g. the foundation model) directed to extract one or more root causes from the description (or to output that a root cause cannot be extracted). For example, the prompt can comprise (or be) a linguistic instruction to the large language model (LLM) directed to extract one or more root causes from the description (or to output that a root cause cannot be extracted). In other words, the machine learning model (here the LLM) does not have to have been specifically trained to extract the root cause. It may already be sufficient that the machine learning model has been trained generally to a certain level of understanding, in particular to a certain level of language understanding, so that the prompt, in particular the linguistic instruction, is understood by the machine learning model and the machine learning model is thus able to extract the root cause(s) from a description.

Evaluating 150 the at least one potentially vulnerable software component as vulnerable or as not vulnerable or, optionally, as unevaluable based on the at least one root cause and the extracted 110 data structure 10 can comprise checking whether the function associated with the at least one root cause is contained in the extracted 110 data structure 10 (and is actually used).

A concrete exemplary example is described in more detail below. For example, a p-code (see example below) can be generated from the source code (see example below) or the compiled binary code (see example below) of software, on the basis of which p-code a control flow graph can be generated, comparable to the illustrative representation in FIG. 2. For example, based on the source code or other development work done, the packages included can be identified and these findings can be used to generate a (complete) list of all possible included vulnerabilities. For each vulnerability found, a prompt can then be used, for example in Open AI's ChatGPT (see example prompt below), to identify at least one main cause. This root cause is then used, for example, to check the control flow graph to see whether this function is included and used.

A source code example is shown below:

| “#include<stdio.h> | |
|---|---|
| int loop(int i) { | |
| for(int a=0; a < i; a++){ | |
| printf(“%d \n”,a); | |
| } | |
| } | |
| int main( ) { | |
| printf(“Start IDA Tracing\n”); | |
| int i=2; // change this to increase or decrease the trace size | |
| int x=loop(i); | |
| printf(“Stop IDA Tracing\n”); | |
| return 0; | |
| }” | |
| A (compiled) binary code example is shown below: | |
| “01 00 02 00 25 64 20 0a 00 53 74 61 72 74 20 49 | |
| 44 41 20 54 72 61 63 69 6e 67 00 53 74 6f 70 20 | |
| 49 44 41 20 54 72 61 63 69 6e 67 00 01 1b 03 3b” | |
| A p-code example is shown below: | |
| “ | |
| ************************************************************** | |
| | * FUNCTION * |
| ************************************************************** | |
| undefined main( ) | |
| undefined AL:1 | <RETURN> |
| undefined4 Stack[−0xc]:4 local_c XREF[2]: 0010119c(W), | |
| | 001011a3(R) |
| undefined4 Stack[−0x10]:4 local_10 XREF[1]: 001011ad(W) | |
| main | XREF[4]: Entry Point(*), |
| | _start:00101074(*), 00102058, |
| | 00102110(*) |
| 00101185 55 | |
| | $Ued00:8 = COPY RBP |
| | RSP = INT_SUB RSP, 8:8 |
| | STORE ram(RSP), $Ued00:8 |
| 00101186 48 89 e5 | |
| | RBP = COPY RSP |
| 00101189 48 83 ec 10 | |
| | CF = INT_LESS RSP, 16:8 |
| | OF = INT_SBORROW RSP, 16:8 |
| | RSP = INT_SUB RSP, 16:8 |
| | SF = INT_SLESS RSP, 0:8 |
| | ZF = INT_EQUAL RSP, 0:8 |
| | $U13180:8 = INT_AND RSP, 0xff:8 |
| | $U13200:1 = POPCOUNT $U13180:8 |
| | $U13280:1 = INT_AND $U13200:1, 1:1 |
| | PF = INT_EQUAL $U13280:1, 0:1 |
| 0010118d 48 8d 05 | = “Start IDA Tracing” |
| 75 0e 00 00 | |
| | RAX = COPY 0x102009:8 |
| 00101194 48 89 c7 | = “Start IDA Tracing” |
| | RDI = COPY RAX |
| 00101197 e8 94 fe | int puts(char * _{——}s) |
| ff ff | |
| | RSP = INT_SUB RSP, 8:8 |
| | STORE ram(RSP), 0x10119c:8 |
| | CALL *[ram]0x101030:8 |
| 0010119c c7 45 fc | |
| 02 00 00 00 | |
| | $U3100:8 = INT_ADD RBP, −4:8 |
| | $Ubf80:4 = COPY 2:4 |
| | STORE ram($U3100:8), $Ubf80:4 |
| 001011a3 8b 45 fc | |
| | $U3100:8 = INT_ADD RBP, −4:8 |
| | $Ubf00:4 = LOAD ram($U3100:8) |
| | EAX = COPY $Ubf00:4 |
| | RAX = INT_ZEXT EAX |
| 001011a6 89 c7 | |
| | EDI = COPY EAX |
| | RDI = INT_ZEXT EDI |
| 001011a8 e8 9c ff | undefined loop( ) |
| ff ff | |
| | RSP = INT_SUB RSP, 8:8 |
| | STORE ram(RSP), 0x1011ad:8 |
| | CALL *[ram]0x101149:8 |
| 001011ad 89 45 f8 | |
| | $U3100:8 = INT_ADD RBP, −8:8 |
| | $Ubf00:4 = COPY EAX |
| | STORE ram($U3100:8), $Ubf00:4 |
| 001011b0 48 8d 05 | = “Stop IDA Tracing” |
| 64 0e 00 00 | |
| | RAX = COPY 0x10201b:8 |
| 001011b7 48 89 c7 | = “Stop IDA Tracing” |
| | RDI = COPY RAX |
| 001011ba e8 71 fe | int puts(char * _{——}s) |

ff ff

RSP = INT_SUB RSP, 8:8
STORE ram(RSP), 0x1011bf:8
CALL *[ram]0x101030:8

```
  001011bf b8 00 00
    00 00
```

RAX = COPY 0:8

001011c4 c9

RSP = COPY RBP
RBP = LOAD ram(RSP)
RSP = INT_ADD RSP, 8:8

001011c5 c3

RIP = LOAD ram(RSP)
RSP = INT_ADD RSP, 8:8
RETURN RIP”

The following is an example extract from a list of known vulnerabilities in English:
“A memory leak in the mlx5_fpga_conn_create_cq( ) function in drivers/net/ethernet/mellanox/mlx5/core/fpga/conn.c in the Linux kernel before 5.3.11 allows attackers to cause a denial of service (memory consumption) by triggering mlx5_vector2eqn( ) failures, aka CID-c8c2a057fdc7
A flaw was discovered in OpenLDAP before 2.4.57 leading to a double free and slapd crash in the saslAuthzTo processing, resulting in denial of service
. . . ”=

Below is an example comprising an example prompt in English and the answers generated by the machine learning model for each description:
“You are expected to deliver answers as a security engineer. As such I want you to extract the root cause of a CVE from its description. Answer as concisely as possible. CVE: {cve}=>
Answer: {answer}
CVE: A memory leak in the mlx5_fpga_conn_create_cq( ) function in drivers/net/ethernet/mellanox/mlx5/core/fpga/conn.c in the Linux kernel before 5.3.11 allows attackers to cause a denial of service (memory consumption) by triggering mlx5_vector2eqn( ) failures, aka CID-c8c2a057fdc7.
=>Answer:
mlx5_fpga_conn_create_cq( )
mlx5_vector2eqn( )
CVE: A heap out-of-bounds read/write vulnerability in the Linux Kernel traffic control (QoS) subsystem can be exploited to achieve local privilege escalation. The qfq_change_class function does not properly limit the lmax variable which can lead to out-of-bounds read/write. If the TCA_QFQ_LMAX value is not offered through nlattr, lmax is determined by the MTU value of the network device. The MTU of the loopback device can be set up to 2\hat{ }31-1 and as a result, it is possible to have an Imax value that exceeds QFQ_MIN_LMAX. We recommend upgrading past commit 3037933448f60f9acb705997eae62013ecb81e0d.
=>Answer:
qfq_change_class( )
CVE: “managed-keys” is a feature which allows a BIND resolver to automatically maintain the keys used by trust anchors which operators configure for use in DNSSEC validation. Due to an error in the managed-keys feature it is possible for a BIND server which uses managed-keys to exit due to an assertion failure if, during key rollover, a trust anchor's keys are replaced with keys which use an unsupported algorithm. Versions affected: BIND 9.9.0->9.10.8-P1, 9.11.0->9.11.5-P1, 9.12.0->9.12.3-P1, and versions 9.9.3-S1->9.11.5-S3 of BIND 9 Supported Preview Edition. Versions 9.13.0->9.13.6 of the 9.13 development branch are also affected. Versions prior to BIND 9.9.0 have not been evaluated for vulnerability to CVE-2018-5745.
=>Answer:
root cause not identifiable
CVE: A use-after-free in Busybox's awk applet leads to denial of service and possibly code execution when processing a crafted awk pattern in the hash_init function
=>Answer:
hash_init( )
CVE: A memory leak in the mlx5_fpga_conn_create_cq( ) function in drivers/net/ethernet/mellanox/mlx5/core/fpga/conn.c in the Linux kernel before 5.3.11 allows attackers to cause a denial of service (memory consumption) by triggering mlx5_vector2eqn( ) failures, aka CID-c8c2a057fdc7
=>Answer:
mlx5_fpga_conn_create_cq( )
CVE: A flaw was discovered in OpenLDAP before 2.4.57 leading to a double free and slapd crash in the saslAuthzTo processing, resulting in denial of service
=>Answer:
saslAuthzTo( )”

For example, for the prompt “You are expected to deliver answers as a security engineer. As such I want you to extract the root cause of a CVE from its description. Answer as concisely as possible. CVE: {cve}=>Answer: {answer}” and the description “A flaw was discovered in OpenLDAP before 2.4.57 leading to a double free and slapd crash in the saslAuthzTo processing, resulting in denial of service”, the machine learning model outputs the root cause “saslAuthzTo( )”.

Also disclosed is a computer system designed to execute the computer-implemented method 100 for automated detection of known vulnerabilities in a static test of software. The computer system can comprise a processor and/or a working memory.

Also disclosed is a computer program designed to execute the computer-implemented method 100 for automated detection of known vulnerabilities in a static test of software. The computer program can be present, for example, in interpretable or in compiled form. For execution, it can (even in parts) be loaded into the RAM of a computer, for example as a bit or byte sequence.

Also disclosed is a computer-readable medium or signal that stores and/or contains the computer program. The medium can comprise, for example, any one of RAM, ROM, EPROM, HDD, SSD, . . . , on/in which the signal is stored.

What is claimed is:

1. A computer-implemented method for automated detection of known vulnerabilities in a static test of software, the method comprising the following steps:
extracting a data structure of a code of the software;
identifying one or more software components on which the software depends based on the code, and/or the extracted data structure, and/or a software bill of materials of the software;
evaluating, for at least one identified software component, whether the software component is associated with a known vulnerability, wherein one or more potentially vulnerable software components result;
applying, for at least one potentially vulnerable software component, a machine learning model to a description associated with the known vulnerability, wherein the machine learning model is trained and configured to determine at least one root cause from at least the description and a prompt; and
evaluating the at least one potentially vulnerable software component as vulnerable or as not vulnerable based on the at least one root cause and the extracted data structure.

2. The method according to claim 1, wherein the software is configured to control and/or regulate and/or monitor a computing unit of a vehicle.

3. The method according to claim 1, wherein the method is carried out in an electronic programming environment.

4. The method according to claim 1, further comprising:
outputting at least one software component evaluated as vulnerable via a user interface.

5. The method according to claim 1, wherein the code includes a source code.

6. The method according to claim 1, wherein the code includes compiled binary code.

7. The method according to claim 1, wherein the data structure includes an abstract syntax tree.

8. The method according to claim 1, wherein the data structure includes a control flow graph.

9. The method according to claim 1, wherein extracting the data structure of the code includes generating an abstract syntax tree of the code and generating a control flow graph from the abstract syntax tree.

10. The method according to claim 1, wherein each software component includes a software package and/or a function and/or a library.

11. The method according to claim 1, wherein the evaluating, for at least one identified software component, whether the software component is associated with a known vulnerability, is based on a comparison of identifiers and/or metadata.

12. The method according to claim 11, wherein each identifier includes a unique name of a software package and/or a function and/or a library.

13. The method according to claim 11, wherein the metadata includes a version number and/or a type of use and/or a configuration and/or a build option.

14. The method according to claim 1, wherein the machine learning model includes a foundation model.

15. The method according to claim 1, wherein the prompt includes an instruction to the machine learning model directed to extract one or more root causes from the description.

16. The method according to claim 14, wherein the machine learning model includes a large language model (LLM).

17. The method according to claim 1, wherein the at least one root cause is a function, and wherein the function is contained in the description.

18. The method according claim 16, wherein the prompt includes a linguistic instruction to the large language model (LLM) directed to extract one or more root causes from the description.

19. The method according to claim 17, wherein the evaluating of the at least one potentially vulnerable software component as vulnerable or as not vulnerable based on the at least one root cause and the extracted data structure includes checking whether the function associated with the at least one root cause is contained in the extracted data structure.

20. A computer system configured to automatedly detect known vulnerabilities in a static test of software, the computer system configured to:
extract a data structure of a code of the software;
identify one or more software components on which the software depends based on the code, and/or the extracted data structure, and/or a software bill of materials of the software;
evaluate, for at least one identified software component, whether the software component is associated with a known vulnerability, wherein one or more potentially vulnerable software components result;
apply, for at least one potentially vulnerable software component, a machine learning model to a description associated with the known vulnerability, wherein the machine learning model is trained and configured to determine at least one root cause from at least the description and a prompt; and
evaluate the at least one potentially vulnerable software component as vulnerable or as not vulnerable based on the at least one root cause and the extracted data structure.

21. A non-transitory computer-readable medium on which is stored a computer program for automated detection of known vulnerabilities in a static test of software, the computer program, when executed by a computer, causing the computer to perform the following steps:
extracting a data structure of a code of the software;
identifying one or more software components on which the software depends based on the code, and/or the extracted data structure, and/or a software bill of materials of the software;
evaluating, for at least one identified software component, whether the software component is associated with a known vulnerability, wherein one or more potentially vulnerable software components result;
applying, for at least one potentially vulnerable software component, a machine learning model to a description associated with the known vulnerability, wherein the machine learning model is trained and configured to determine at least one root cause from at least the description and a prompt; and
evaluating the at least one potentially vulnerable software component as vulnerable or as not vulnerable based on the at least one root cause and the extracted data structure.
